(19) United States
(12) Patent Application Publication
(10) Pub. No.: US 2018/0025260 A1
(43) Pub. Date: Jan. 25, 2018

(54) PRINT CONTROL SYSTEM, PRINT CONTROL METHOD, AND NON-TRANSITORY COMPUTER READABLE MEDIUM

(71) Applicant: FUJI XEROX CO., LTD., Tokyo (JP)

(72) Inventor: Osamu ENDO, Kanagawa (JP)

(73) Assignee: FUJI XEROX CO., LTD., Tokyo (JP)

(21) Appl. No.: 15/445,373

(22) Filed: Feb. 28, 2017

(30) Foreign Application Priority Data
Jul. 19, 2016 (JP) 2016-141113

(51) Int. Cl. G06K 15/00; G06K 15/14

(52) U.S. Cl. CPC G06K 15/4065; G06K 15/4095; G06K 15/14

(57) ABSTRACT

A print control system includes a memory controller, a receiver, and a limiter. The memory controller stores permission information in a memory, the permission information representing a user who is permitted to use a medium contained in a paper feeder of an image forming apparatus. The receiver receives a print setting including a type of a medium to be used and identification information identifying a user. If use of the medium of the type included in the print setting by the user identified by the identification information included in the print setting is not permitted in the permission information, the limiter limits the use of the medium by the user.

### CROSS-REFERENCE TO RELATED APPLICATIONS

This application is based on and claims priority under 35 USC 119 from Japanese Patent Application No. 2016-141113 filed Jul. 19, 2016.

### BACKGROUND

### Technical Field

The present invention relates to a print control system, a print control method, and a non-transitory computer readable medium.

### SUMMARY

According to an aspect of the invention, there is provided a print control system including a memory controller, a receiver, and a limiter. The memory controller stares permission information in a memory, the permission information representing a user who is permitted to use a medium contained in a paper feeder of an image forming apparatus. The receiver receives a print setting including a type of a medium to be used and identification information identifying a user. If use of the medium of the type included in the print setting by the user identified by the identification information included in the print setting is not permitted in the permission information, the limiter limits the use of the medium by the user.

### BRIEF DESCRIPTION OF THE DRAWINGS

An exemplary embodiment of the present invention will be described in detail based on the following figures, wherein:

FIG. 1 is a diagram illustrating the configuration of a system;

FIG. 2 is a diagram illustrating the functional configuration of the system;

FIG. 3 is a diagram illustrating the hardware configuration of a printer;

FIG. 4 is a diagram illustrating the hardware configuration of an information terminal;

FIG. 5 is a flowchart illustrating a flow of a process performed by the printer;

FIG. 6 is a diagram illustrating an example of content of a paper feed information table; and

FIG. 7 is a flowchart illustrating a flow of a process performed by the information terminal.

### DETAILED DESCRIPTION

### 1. Configuration

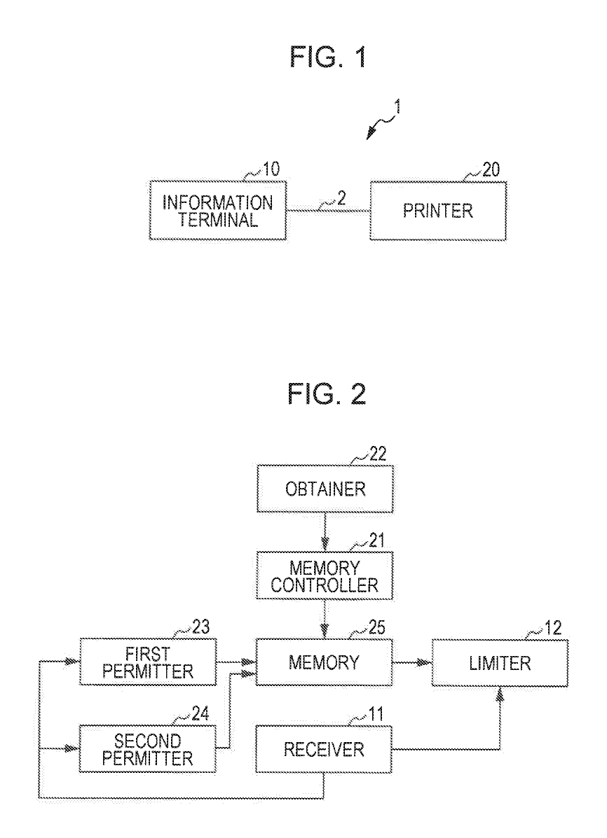

FIG. 1 is a block diagram illustrating the configuration of a system 1 according to an exemplary embodiment. The system 1 includes an information terminal 10 and a printer 20. The information terminal 10 is an apparatus that is operated by a user and is, for example, a personal computer. The printer 20 performs a process of forming an image on a medium, such as paper, using an electrophotographic system or the like. The printer 20 is connected to the information terminal 10 through a communication line 2. The communication line 2 includes at least one of the Internet, a mobile communication network, a telephone line, a local area network (LAN), and the like.

FIG. 2 is a diagram illustrating an example functional configuration of the system 1. The printer 20 includes a memory controller 21, an obtainer 22, a first permitter 23, and a second permitter 24. The information terminal 10 includes a receiver 11 and a limiter 12. The memory controller 21 stores permission information in a memory 25. The permission information represents a user who is permitted to use a medium contained in a paper feeder of image forming apparatus. The receiver 11 receives print setting including a type of a medium to be used and identification information identifying a user. The limiter 12 limits, if use of the medium of the type included in the print setting by the user identified by the identification information included in the print setting is not permitted in the permission information, the use of the medium by the user.

The obtainer obtains the identification information identifying the user in response to the medium being placed in the paper feeder. The first permitter 23 does not accept update of the permission information corresponding to a printing process corresponding to the received print setting until the printing process is performed by the image forming apparatus, and permits update of the permission information corresponding to the printing process if the printing process has been performed by the image forming apparatus. The second permitter 24 does not accept update of the permission information until a predetermined period elapses from when the permission information is stored by the memory controller 21, and permits update of the permission information if the predetermined period has elapsed.

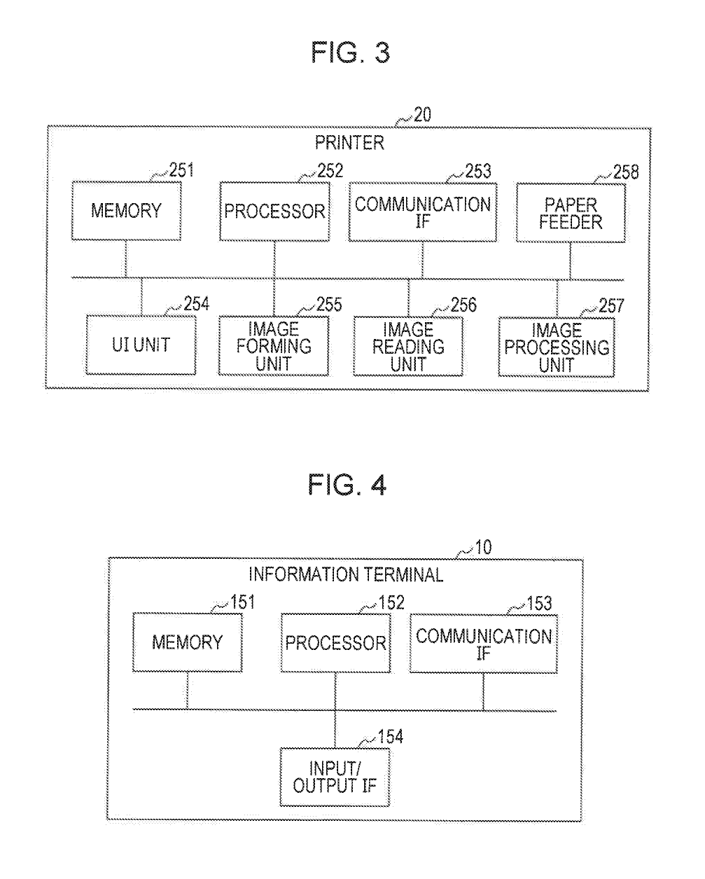

FIG. 3 is a diagram illustrating an example hardware configuration of the printer 20. In FIG. 3, a memory 251 stores various pieces of data. A processor 252 performs data processing in accordance with a program stored in the memory 251. A communication interface (IF) 253 is an interface that performs data communication with an external apparatus through a network. A user interface (UI) unit 254 includes, for example, a touch screen and keys. An image forming unit 255 (an example of an image forming apparatus) forms an image on a medium, such as paper, using an electrophotographic system. An image reading unit 256 optically reads an image of a document. An image processing unit 257 performs various types of image processing.

A paper feeder 258 feeds a medium such as paper to the image forming unit 255. The paper feeder 258 includes plural medium containers and is capable of containing media by size or type. The medium containers are capable of containing media of standardized sizes, such as A4 sheets and B5 sheets, and are also capable of containing media of special sizes, such as envelopes and postcards. In the printer 20, consecutive printing with one print setting may be performed, and each medium container contains a substantial number of media. The memory 251 stores information about the media contained in the individual medium containers. The information about the media represents, for example, the sizes, types, and orientations of the media.

FIG. 4 is a diagram illustrating an example hardware configuration of the information terminal 10. In FIG. 4, a memory 151 stores various pieces of data. A processor 152 performs data processing in accordance with a program stored in the memory 151. A communication interface (IF) 153 is an interface that performs data communication with an external apparatus through a network. An input/output interface (IF) 154 is an interface that receives/transmits operation data or image data from/to an external apparatus. The input/output IF 154 is connected to an operation device such as a keyboard and mouse and a display device such as a liquid crystal display.

In this example, the functions illustrated in FIG. 2 are implemented when the processor 252 or the processor 152 executes a program stored in the memory 251 or the memory 151. The processor 252 and the processor 152 that execute a program correspond to an example of the memory controller 21, the receiver 11, the limiter 12, the obtainer 22, the first permitter 23, and the second permitter 24. The memory 251 and the memory 151 correspond to an example of the memory 25.

### 2. Operation

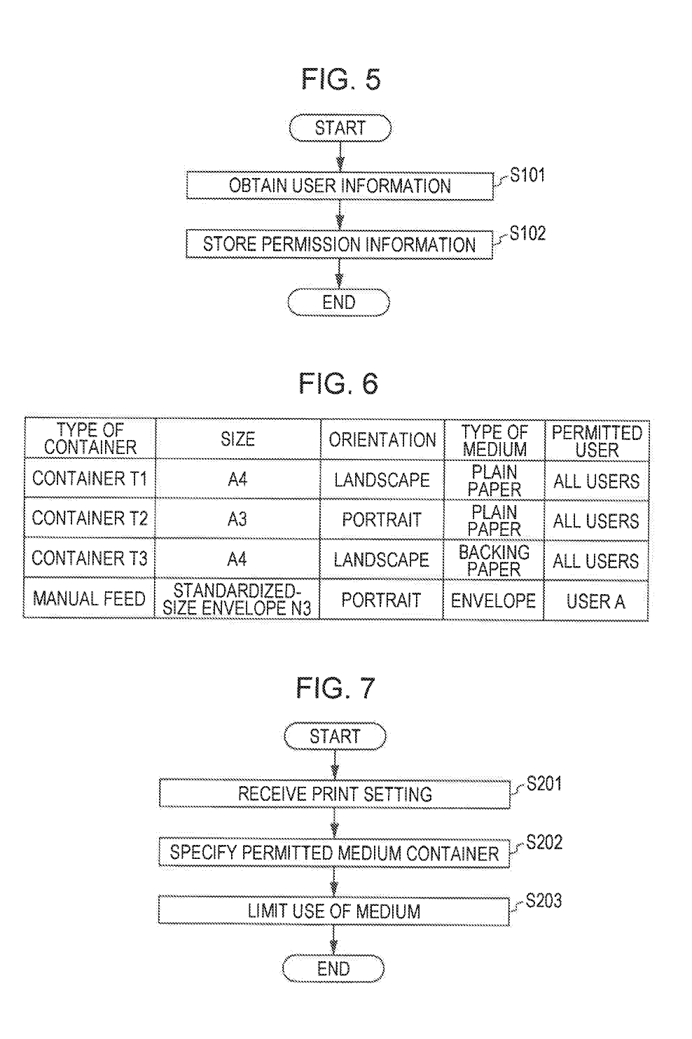

FIG. 5 is a flowchart illustrating a flow of a process performed by the processor 252 of the printer 20. The process illustrated in FIG. 5 may be started in response to a medium being placed in a medium container of the printer 20 by a user or may be started in response to various pieces of information being input from setting screen of the printer 20 by a user using the UI unit 254. The information about the medium placed in the medium container by the user is obtained by the printer 20 through detection by a sensor provided in the paper feeder 258 or through input of information from the setting screen of the printer 20 by the user who has placed the medium in the medium container.

If the sensor of the paper feeder 258 detects that the paper contained in the paper feeder 258 has been changed, the processor 252 displays a screen prompting input of the name of a user or group who is permitted to use the medium. The user inputs the name of a user or group by using the UI unit 254. In step S101, the processor 252 obtains the user information input by the user and sets the user who is permitted to use the medium contained in the medium container. The user information input by the user includes identification information identifying the user (the name of the user or group, a user ID, and so forth). If no user information is registered by the user, use by users is not limited and all users are permitted to use the medium.

In step S102, the processor 252 stores, in the memory 251, permission information representing the user who is permitted to use the medium contained in the medium container. In the exemplary embodiment, the processor 252 stores the permission information in the memory 251 by including the identification information included in the user information obtained in step S101 in the permission information.

FIG. 6 is a diagram illustrating an example of the content of a paper feed information table in which permission information is registered. As illustrated in FIG. 6, in this table, individual items “type of container”, “size”, “orientation”, “type of medium”, and “permitted user” are associated with one another. In the item “type of container” among these items, pieces of identification information identifying medium containers, such as “container T1”, “container T2”, “container T3”, and “manual feed”, are stored. In the item “size”, pieces of information representing the sizes of media, such as “A4”, “A3”, and “standardized-size envelope N3”, are stored. In the item “orientation”, pieces of information representing the orientations of media, such as “landscape” and “portrait”, are stored. In the item “type of medium”, pieces of information representing the types of media, such as “plain paper”, “backing paper”, and “envelope”, are stored, In the item “permitted user”, pieces of permission information representing the users who are permitted to use the media contained in the individual medium containers, such as “all users” and “user A”, are stored.

The user who has placed the medium in the medium container of the printer 20 moves to a place where the information terminal 10 is installed, and performs an operation for opening a screen for performing a print setting by using the operation device connected to the information terminal 10. The processor 152 of the information terminal 10 displays, on the display device, a screen for performing a print setting in accordance with a user operation. The user performs an operation for inputting a print setting by using the operation device while viewing the screen displayed on the display device. This print setting includes the type of the medium to be used in a printing process and the user ID identifying the user.

FIG. 7 is a flowchart illustrating a flow of a process performed by the processor 152 of the information terminal 10. In step S201, the processor 152 of the information terminal 10 receives input of the print setting including the type of the medium to be used and the user ID identifying the user. After receiving the print setting, the processor 152 transmits a request for obtaining paper feed information to the printer 20, the paper feed information being information about the paper feeder 258.

In response to receipt of the request for obtaining paper feed information from the information terminal 10, the printer 20 transmits the paper feed information stored in the paper feed information table stored in the memory 251 to the information terminal 10. The information transmitted at this time includes information representing the sizes and types of the media contained in the individual medium containers and also includes permission information representing the users who are permitted to use the individual media.

In step S202 in FIG. 7, the processor 152 of the information terminal 10 specifies the medium container that is permitted to be used by the user operating the information terminal 10 by referring to the permission information included in the received paper feed information. For example, if the paper feed information illustrated in FIG. 6 is received from the printer 20, a user A is permitted to use the media in all the medium containers. On the other hand, a user B is permitted to use the media contained in the containers T1, T2, and T3 but is not permitted to use the medium set in the manual feed medium container.

In Step S203, if use of the medium of the type included in the received print setting by the user identified by the identification information included in the received print setting is not permitted in the permission information obtained from the printer 20, the processor 152 limits the use of the medium by the user. In the exemplary embodiment, the processor 152 displays a setting screen on a UI unit in accordance with a result specified on the basis of the obtained permission information, and performs control so that the medium use of which is not permitted is unselectable on the setting screen. For example, if the paper feed information illustrated in FIG. 6 is obtained and if the user of the information terminal 10 is “user B”, the processor 152 displays a setting screen on which the manual feed medium container is unselectable. On the other hand, if the paper feed information illustrated in FIG. 6 is obtained and if the user of the information terminal 10 is “user A”, the processor 152 displays a setting screen on which the manual feed medium container is selectable.

Furthermore, in the example illustrated in FIG. 6, only the user A is permitted to use the medium set in the manual feed medium container, and thus the processor 152 determines that the user A uses an envelope “standardized-size envelope N3” set in the manual feed medium container as a medium. In this case, the processor 152 may cause a screen on which the manual feed medium container is already selected to be displayed or may cause a UI screen in a wizard format for selecting the manual feed medium container to be displayed upon an operation of displaying a setting screen being performed by the user A.

The user performs a paint setting by using the UI screen displayed on the UI unit of the information terminal 10 and provides a print instruction by using the UI unit. The processor 152 receives the print setting including the type of the medium to be used and the user ID identifying the user. The processor 152 generates a print request on the basis of the received print setting and transmits the generated print request to the printer 20. The printer 20 receives the print request from the information terminal 10 and performs an image formation process on the medium in accordance with the received print request.

If the user tries to perform printing by using a special medium such as a postcard, envelope, or glossy paper, a misprint occurs if the user does not designate the medium container containing the special medium in a print setting. Also, for example, if a user places a medium in a medium container and after that another user replaces the medium with another medium, trouble such as a misprint occurs. In the exemplary embodiment, a user who is permitted to use a medium contained in a medium container is set, and a medium placed by a certain user is not designated when a user who is not permitted to use the medium performs a print setting.

### 3. MODIFICATION EXAMPLES

The above-described exemplary embodiment is merely an example of the embodiment of the present invention and may be modified as follows. The above-described exemplary embodiment and the individual modification examples described below may be carried out in combination with one another as necessary.

(1) In the above-described exemplary embodiment, a user inputs the name of the user or group to the printer 20 by using the UI unit 254, and thereby the printer 20 obtains the input user information. A method for obtaining user information by the printer 20 is not limited thereto. For example, the printer 20 may obtain user information from information output from a reading device that reads an IC card, or the printer 20 may obtain user information by analyzing image data output from a photographing device that photographs a user. Alternatively, the printer 20 may obtain user information by performing personal authentication using biometric authentication such as vein authentication. Alternatively, the user may input user information by using the operation device of the information terminal 10, and the information terminal 10 may transmit the input user information to the printer 20. Alternatively, user information may be obtained by the printer 20 in response to a medium being placed in the paper feeder 258 or at other timing.

(2) In the above-described exemplary embodiment, the processor 252 of the printer 20 may not accept update of permission information corresponding to a printing process corresponding to the print setting received in step S201 in FIG. 7 until the printing process is performed by the image forming unit 255, whereas the processor 252 may permit update of the permission information corresponding to the printing process if the printing process has been performed by the image forming unit 255. For example, during a period from when a user A places a medium in a medium container to when the user A provides a print instruction, another user may replace the medium contained in the medium container with another medium. If the printer 20 does not accept update of permission information until a user permitted to perform printing performs printing or until the user changes (cancels) the permission information, mistaken update of the permission information may be suppressed.

In this case, if update of the permission information is permitted upon completion of printing and if an instruction to perform a printing process is provided plural times, the medium contained in the medium container may be replaced before a printing request is provided for the second time or thereafter. Thus, a flag indicting that printing processes will be consecutively performed may be set on a print setting screen, and the value of the flag may be reflected in a print request. In this case, if a print request with the flag is received, the processor 252 does not permit update of the permission information even if the printing process corresponding to the permission information is completed.

If update of permission information is prohibited so that a medium is not used by another user as described above and if the user who has placed the medium in a medium container cancels printing and forgets to update the permission information, another user may be unable to use the medium container. Thus, the processor 252 may not accept update of the permission information stored in the memory 251 until a predetermined period elapses from when the permission information is stored in the memory 251, and may permit update of the stored permission information if the predetermined period has elapsed. For example, the processor 252 may store time information representing the time when the medium is placed in the medium container or when the medium is last used in the memory 251, and may permit update of the permission information if a predetermined period has elapsed from the time represented by the time information.

In this case, a print request may be transmitted from the information terminal 10 to the printer 20 after timeout. If the permission information corresponding to the print request is not stored in the memory 251, the printer 20 may not perform a printing process.

(3) in the above-described exemplary embodiment, if use of a medium of a type included in a received print setting by a user identified by identification information included in the received print setting is not permitted in permission information obtained from the printer 20, the processor 152 of the information terminal 10 limits the use of the medium by the user. Alternatively, if use of a medium of a type included in a received print setting by a user identified by identification information included in the received print setting is not permitted in permission information obtained from the printer 20, the processor 152 may give a warning by displaying a message indicating the non-permission on the display device.

(4) In the above-described exemplary embodiment, the functions according to the exemplary embodiment in the system 1 are shared by the printer 20 and the information terminal 10. The manner of sharing the functions by the printer 20 and the information terminal 10 is not limited to that described above. For example, in response to input of permission information through a user operation of the UI unit 254 of the printer 20, the printer 20 may transmit the input permission information to the information terminal 10 and the information terminal 10 may store the permission information in the memory 151. The functions according to the above-described exemplary embodiment may be provided by at least one of the printer 20 and the information terminal 10.

In the above-described exemplary embodiment, the system 1 including a single printer 20 and a single information terminal 10 is illustrated, but the apparatuses constituting the system 1 are not limited to those described above. For example, plural information terminals 10 may be included in the system 1. Alternatively, the functions of the system 1 may be shared by plural printers 20 and plural information terminals 10.

(5) In the above-described exemplary embodiment, programs executed by the processor 152 of the information terminal 10 or the processor 252 of the printer 20 may be downloaded through a communication line such as the Internet. Alternatively, these programs may be provided by being recorded on a computer readable recording medium, such as a magnetic recording medium (magnetic tape, magnetic disk, or the like), optical recording medium (optical disc or the like), a magneto-optical recording medium, or a semiconductor memory.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A print control system comprising:
a memory controller that stores permission information in a memory, the permission information representing a user who is permitted to use a medium contained in a paper feeder of an image forming apparatus;
a receiver that receives a print setting including a type of a medium to be used and identification information identifying a user; and
a limiter that, if use of the medium of the type included in the print setting by the user identified by the identification information included in the print setting is not permitted in the permission information, limits the use of the medium by the user.

2. The print control system according to claim 1, further comprising:
an obtainer that obtains the identification information identifying the user in response to the medium being placed in the paper feeder, wherein
the memory controller registers, in the memory, the user identified by the identification information obtained by the obtainer.

3. The print control system according to claim 1, further comprising:
a first permitter that does not accept update of the permission information corresponding to a printing process corresponding to the received print setting until the printing process is performed by the image forming apparatus and that permits update of the permission information corresponding to the printing process if the printing process has been performed by the image forming apparatus.

4. The print control system according to claim 2, further comprising:
a first permitter that does not accept update of the permission information corresponding to a printing process corresponding to the received print setting until the printing process is performed by the image forming apparatus and that permits update of the permission information corresponding to the printing process if the printing process has been performed by the image forming apparatus.

5. The print control system according to claim 1, further comprising:
a second permitter that does not accept update of the permission information stored by the memory controller until a predetermined period elapses from when the permission information is stored by the memory controller and that permits update of the stored permission information if the predetermined period has elapsed.

6. The print control system according to claim 2, further comprising:
a second permitter that does not accept update of the permission information stored by the memory controller until a predetermined period elapses from when the permission information is stored by the memory controller and that permits update of the stored permission information if the predetermined period has elapsed.

7. The print control system according to claim 3, further comprising:
a second permitter that does not accept update of the permission information stored by the memory controller until a predetermined period elapses from when the permission information is stored by the memory controller and that permits update of the stored permission information if the predetermined period has elapsed.

8. The print control system according to claim 4, further comprising:
a second permitter that does not accept update of the permission information stored by the memory controller until a predetermined period elapses from when the permission information is stored by the memory controller and that permits update of the stored permission information if the predetermined period has elapsed.

9. A print control method comprising:
storing permission information in a memory, the permission information representing a user who is permitted to use a medium contained in a paper feeder of an image forming apparatus;
receiving a print setting including a type of a medium to be used and identification information identifying a user; and
if use of the medium of the type included in the print setting by the user identified by the identification information included in the print setting is not permitted in the permission information, limiting the use of the medium by the user.

10. A non-transitory computer readable medium storing a program causing a computer to execute a process for controlling printing, the process comprising:
storing permission information in a memory, the permission information representing a user who is permitted to use a medium contained in a paper feeder of an image forming apparatus;
receiving a print setting including a type of a medium to be used and identification information identifying a user; and
if use of the medium of the type included in the print setting by the user identified by the identification information included in the print setting is not permitted in the permission information, limiting the use of the medium by the user.
